(19) United States
(12) Patent Application Publication
(10) Pub. No.: US 2026/0086274 A1
(43) Pub. Date: Mar. 26, 2026

(54) METHOD FOR PRODUCING AN OPTICAL ELEMENT, OPTICAL ELEMENT AND COATING ARRANGEMENT

(71) Applicant: Carl Zeiss SMT GmbH, Oberkochen (DE)

(72) Inventors: Martin HERMANN, Heidenheim (DE); Katharina BROCH, Aalen (DE); Felix SCHMIDT, Aalen (DE); Hartmut ENKISCH, Aalen (DE); Sebastian STROBEL, Aalen (DE)

(21) Appl. No.: 19/410,034

(22) Filed: Dec. 5, 2025

Related U.S. Application Data
(63) Continuation of application No. PCT/EP2024/063176, filed on May 14, 2024.

(30) Foreign Application Priority Data
Jun. 7, 2023 (DE) 10 2023 205 340.3

(51) Int. Cl. G02B 5/08

(52) U.S. Cl. CPC G02B 5/08

(57) ABSTRACT

In a method for producing an optical element, at least one substrate is supplied with coating material from at least one source for depositing a respective layer system on the substrate. A plurality of zones (111, 112, 121, 122) that are laterally adjacent to one another in at least one predefined direction and each have a defined layer thickness profile and a defined layer composition are formed by targeted spatially resolved selection and/or treatment of the deposited coating material and/or the substrate. These zones differ from each other in their layer thickness profiles and/or their layer compositions. The average dimension of each of the zones in the predefined direction is between 0.1 mm and 2 cm. The optical element is a mirror array with plural mirror elements. For different substrates of this mirror array, mutually different layer thickness profiles and/or layer compositions of the respectively deposited layer system are generated.

### CROSS REFERENCE TO RELATED APPLICATIONS

This is a Continuation of International Application PCT/EP2024/063176 which has an international filing date of May 14, 2024, and the disclosure of which is incorporated in its entirety into the present Continuation by reference. This Continuation also claims foreign priority under 35 U.S. C. § 119(a)-(d) to and also incorporates by reference, in its entirety, German Patent Application DE 10 2023 205 340.3 filed on Jun. 7, 2023.

### FIELD

The invention relates to a method for producing an optical element, in particular a microlithographic optical element, as well as to an optical element, a coating arrangement and a microlithographic projection exposure apparatus.

### BACKGROUND

Microlithography is used to produce microstructured component parts, such as integrated circuits or liquid crystal displays (LCDs). The microlithography process is performed in a so called projection exposure apparatus, which comprises an illumination device and a projection lens. The image of a mask (=reticle) illuminated with the illumination device is projected by the projection lens onto a substrate (e.g. a silicon wafer) coated with a light-sensitive layer (photoresist) and arranged in the image plane of the projection lens, in order to transfer the mask structure to the light-sensitive coating on the substrate.

In projection lenses designed for the extreme ultraviolet (EUV) range, e.g. at wavelengths of e.g. approximately 13 nm, approximately 11 nm, approximately 7 nm or approximately 4 nm, mirrors are used as optical components for the imaging process, due to the lack of availability of suitable light-transmissive refractive materials.

The use of mirror arrangements constructed from a plurality of individual mirrors (e.g. in the form of facet mirrors or pupil facet mirrors) for flexibly setting different illumination angle distributions is known not only in the illumination device of a microlithographic projection exposure apparatus designed for EUV operation but also in microlithographic projection exposure apparatuses designed for operation at wavelengths in the deep ultraviolet (DUV) range (e.g. at wavelengths of approx. 248 nm or approx. 193 nm). These individual mirrors may be designed to be settable or tiltable independently of one another via respective flexures and may in turn be constructed as blocks of individual micromirrors in the form of microelectromechanical systems (so-called “MEMS mirrors”).

For example, arrangements in which magnetron sputtering is utilized are used to produce the reflective coating. In this case, the respective mirror substrate (this is understood as meaning the carrier for the layer to be applied in the coating method or the layer system to be applied) is guided via the coating positions that face the respective targets (which are assigned a corresponding coating material). Predefined layer thickness profiles can be set in a manner known in general to a person skilled in the art by changing the speed, changing the power or using suitable stops. In a coating arrangement in which the material is applied to the mirror substrate via electron beam evaporation, predefined layer thickness profiles can be set accordingly by using suitable stops. An azimuthal thickness profile can also be set in a coating arrangement in which the material is applied to the mirror substrate via electron beam evaporation: In this case, (rotation) speed profiles are combined with a mask, and the rate can also be varied in a similar way.

In practice—in particular in the course of the progressive development toward systems with higher numerical apertures (NA) as well as for providing sufficient pupil filling degrees—there is a need in the art to provide zones of different layer thickness and/or different layer composition even with comparatively small zone sizes, that is to say, in other words, to be able to control the layer thickness profile or the layer composition with a correspondingly low spatial wavelength during mirror production. This is particularly important in scenarios in which a high overall transmission as well as uniformity of the optical system are intended to be ensured even with a significant variation in the angle of incidence of the electromagnetic radiation incident on the relevant mirror or the mirror arrangement during operation of the optical system.

Targeted control of the layer thickness profile and composition is therefore of great importance in order to improve the reflectivity and ultimately the overall performance of the optical system.

In relation to the prior art, reference is made merely by way of example to DE 10 2016 201 564 A1, DE 10 2015 225 535 A1, DE 10 2015 217 603 A1, DE 10 2012 215 359 A1, DE 10 2012 204 833 A1, WO 2022/008102 A1 and U.S. Pat. No. 10,423,073 B2.

### SUMMARY

Against the above background, it is one object of the present invention to provide a method for producing an optical element as well as an optical element and a coating arrangement, which make it possible to realize zones of different layer thickness and/or layer composition even for comparatively small zone sizes.

These and other objects are achieved by the features of the coordinate patent claims.

According to one formulation the invention relates to a method for producing an optical element, in particular a microlithographic optical element, in a coating process carried out in a coating arrangement,
wherein at least one substrate is supplied with coating material from at least one source for depositing in each case a layer system on the substrate; and
wherein a plurality of zones that are laterally adjacent to one another in at least one predefined direction and each have a defined layer thickness profile and a defined layer composition are formed by targeted spatially resolved selection and/or treatment of the deposited coating material and/or the substrate, wherein these zones differ from one another in terms of their layer thickness profile and/or their layer composition;
wherein the average dimension of the zones in the predefined direction is in the range of 0.1 mm to 2 cm in each case;
wherein the optical element is a mirror array with a plurality of mirror elements; and
wherein, for different substrates of this mirror array, mutually different layer thickness profiles and/or layer compositions of the respectively deposited layer system are generated.

The wording “selection of the deposited coating material” should be understood in the sense of the present application as meaning that this selection can be carried out alternatively before, during or after the deposition of the coating material on the substrate, depending on the embodiment and as described below.

In the sense of the present application, the wording “defined layer thickness profile” is also intended to include a constant layer thickness profile.

According to a further aspect, the disclosure also comprises a method for producing an optical element, in particular a microlithographic optical element, in a coating process carried out in a coating arrangement, wherein at least one substrate is supplied with coating material from at least one source for depositing a layer system on the substrate in each case, and wherein a plurality of zones that are laterally adjacent to one another in at least one predefined direction and each have a defined layer thickness profile and a defined layer composition are formed by targeted spatially resolved selection and/or treatment of the deposited coating material and/or the substrate, wherein these zones differ from one another in terms of their layer thickness profile and/or their layer composition, wherein the average dimension of the zones in the predefined direction is in the range of 0.1 mm to 2 cm in each case. In this case, the optical element may be a mirror arrangement, in particular a mirror array having a plurality of (optionally also independently adjustable) mirror elements, or an individual mirror. Further, according to one aspect of the disclosure, the optical element can also be a lens element, wherein the layer system can be deposited, for example, in order to form an anti-reflective layer (AR layer).

The layer thickness profile and/or the layer composition of a layer system can be varied on the same substrate or even over a plurality of substrates. In the case of the application according to the invention to the production of a mirror array, the plurality of (mirror) substrates in particular can also be provided or assembled in a common module.

In the case of the application according to the invention to the production of a mirror array, zones which differ from one another in terms of the layer thickness profile and/or their layer composition, or corresponding zone boundaries between adjacent zones, can also be generated within the same mirror element (and not only at the respective boundaries of adjacent mirror elements). In other words, in particular, it is also feasible according to the invention to produce mirror arrays in which the respective boundaries between zones of different layer thicknesses or layer compositions do not correspond to the boundaries between adjacent mirror elements.

The layer system may comprise, in particular, a reflection layer system, e.g. a multilayer system of alternately arranged molybdenum (Mo) and silicon (Si) layers of an (NI) mirror (NI=“normal incidence”) designed for operation under normal incidence or also a single layer of e.g. ruthenium (Ru) of a (GI) mirror (GI=“grazing incidence”) designed for operation under grazing incidence, as well as possibly also other functional layers. The above-mentioned layer materials of molybdenum (Mo)/silicon (Si) and ruthenium (Ru) are each suitable for use at an operating wavelength of approximately 13 nm, but other layer materials (e.g. molybdenum (Mo)/(boron (B) for an operating wavelength of approximately 11 nm and lanthanum (La)/boron (B) for an operating wavelength of approximately 7 nm) are suitable for other operating wavelengths.

The invention is associated in particular with the concept of realizing zones of different layer thickness and/or different layer composition for comparatively small zone sizes or spatial wavelengths in the range of 0.1 mm to 2 cm when producing an optical element such as in particular a mirror arrangement by carrying out targeted spatially resolved selection and/or treatment of the deposited coating material and/or the substrate when depositing a layer system on one or more substrates by supplying coating material from at least one source.

The selection in turn can be carried out according to the invention in a different way, for which different embodiments are also described below. Furthermore, some embodiments include at least one selective treatment step which acts locally in a targeted manner on a scale of comparatively low spatial wavelengths and can be used to provide zones of different layer thickness and/or different layer composition with the above-mentioned comparatively small zone sizes in the range of 0.1 mm to 2 cm and with comparatively sharp transitions. The treatment may only include, for example, doping, surface modification, passivation, tempering or light-induced etching.

According to one embodiment, a transition zone between adjacent zones has a maximum width of 1 mm.

According to a further embodiment, a transition zone between adjacent zones has a predefined monotonous profile of a function describing the location dependence of the layer thickness and/or the layer composition. The width of this transition zone can be in particular in the range of 0.1 mm to 2 cm. In this configuration, a gradual, optionally also continuous or quasi-continuous transition between the aforementioned zones can be provided; in this case, the function describing the layer composition can describe, for example, the relationship between two layer materials.

According to one embodiment, a plurality of zones each with a defined layer thickness profile and a defined layer composition, which differ in terms of the layer thickness profile and/or their layer composition, are generated on the same substrate.

According to one embodiment, the selection of the coating material comprises partially blocking out and/or partially deflecting coating material such that this coating material does not contribute to the deposition of the layer system on the at least one substrate.

According to one embodiment, this partial blocking out of coating material takes place via at least one mask which is arranged at a defined distance from at least one substrate while the coating process is being carried out.

According to one embodiment, this defined distance is in the range of 0.1 mm to 2 cm.

According to one embodiment, the selection of the coating material comprises partially electrically charging the at least one substrate.

According to one embodiment, coating material is partially blocked out via a protective resist, with which the at least one substrate is treated before carrying out the coating process.

According to one embodiment, the treatment of the deposited coating material and/or the substrate comprises partially tempering the at least one substrate after carrying out the coating process.

According to one embodiment, the optical element is designed for an operating wavelength of less than 400 nm, in particular less than 250 nm, more particularly less than 200 nm.

According to a further embodiment, the optical element is designed for an operating wavelength of less than 30 nm, in particular less than 15 nm. In particular, the optical element may be designed for wavelengths of, for example, approximately 13 nm, approximately 11 nm, approximately 7 nm or approximately 4 nm.

According to one embodiment, the spatially resolved selection and/or treatment of the deposited coating material comprises removing coating material.

According to a further embodiment, the spatially resolved selection and/or treatment of the deposited coating material comprises implanting material.

According to a further embodiment, the spatially resolved selection and/or treatment of the deposited coating material and/or the substrate comprises modifying the substrate and/or the substrate surface and/or a previously deposited material.

Aspects of the invention also relate to an optical element, in particular a microlithographic optical element, which is produced using a method having the features described above.

The invention also relates to a coating arrangement for producing an optical element, in particular a microlithographic optical element, having a process chamber for receiving at least one substrate, at least one source for providing coating material, and at least one drive unit for carrying out a relative movement of the source and the substrate, wherein the coating arrangement is configured to carry out a method with the above-described features.

The invention furthermore also relates to a microlithographic projection exposure apparatus comprising an illumination device and a projection lens, wherein the illumination device, during operation of the projection exposure apparatus, illuminates a mask situated in an object plane of the projection lens, and the projection lens images structures on the mask onto a light-sensitive layer situated in an image plane of the projection lens, wherein the projection exposure apparatus comprises at least one optical element that was produced using a method having the above-described features.

Further configurations of the invention can be gathered from the description and the subclaims.

The invention is explained in greater detail below on the basis of exemplary embodiments illustrated in the accompanying figures.

### BRIEF DESCRIPTION OF THE DRAWINGS

In the figures:

FIGS. 1A-2D show schematic illustrations for describing concepts associated with the invention, in which

FIG. 1A shows a substrate, FIG. 1B shows a substrate having a transition zone separating two differing zones, and FIG. 1C shows a transition zone having a gradient profile, and

FIG. 2A shows a MEMS mirror array, FIGS. 2B and 2D show zone boundaries within MEMS mirrors, and FIG. 2C shows zone boundaries between adjacent MEMS mirrors;

FIGS. 3A-4F show schematic illustrations for explaining feasible embodiments of a method according to the invention using a mask which is arranged at a defined distance from the mirror substrate while the coating process is being carried out, in which

FIGS. 3A and 3B show (in top view and side view, respectively) the mask and the substrate,

FIGS. 3C and 3D show (in top view and side view, respectively) the mask, a layer system, and the substrate,

FIGS. 3E and 3F show (in top view and side view, respectively) the substrate and two layer systems formed in first and second passes,

FIGS. 4A and 4B show (in top view and side view, respectively) an unmasked substrate,

FIGS. 4C and 4D show (in top view and side view, respectively) the mask, a layer system, and the substrate,

FIGS. 4E and 4F show (in top view and side view, respectively) the substrate and the two layer systems formed in first and second passes;

FIGS. 5A-5C show schematic illustrations for explaining a feasible embodiment of a method according to the invention with partial tempering of the mirror substrate after carrying out the coating process, wherein FIG. 5A shows a homogenously coated mirror array, FIG. 5B shows the array with a tempered region thereof, and FIG. 5C shows the tempered region further treated;

FIGS. 6A-7B show schematic illustrations for explaining two exemplary embodiments of a method according to the invention, in which the selection of the coating material comprises partially electrically charging the mirror substrate, in which FIGS. 6A and 7A show arrays with substrate regions electrically charged either positively or negatively, and

FIGS. 6B and 7B show these arrays after the coating process has been carried out;

FIGS. 8A-8G show schematic illustrations for explaining a further exemplary embodiment of a method according to the invention, in which coating material is partially blocked out via a protective resist, with which the mirror substrate is treated (FIG. 8A) before carrying out the coating process including homogeneous coating (FIG. 8B), removal of the resist (FIG. 8C), restructured application of a protective resist (FIG. 8D—top view—and FIG. 8E—side view), further homogeneous coating (FIG. 8F), and completion of the coating process (FIG. 8G);

FIG. 9 shows a schematic illustration of a basic structure of a feasible coating arrangement according to the invention;

FIGS. 10A-10D show schematic illustrations, each in sectional views, for explaining exemplary application scenarios of the invention, in which laterally adjacent regions or elements are shown without thickness variations (FIG. 10A), with a thickness variation only in the capping layer (FIG. 10B), with a thickness variation only in the optically effective part (FIG. 10C), and with a thickness variation only in the bottom layer (FIG. 10D);

FIGS. 11A-11F show schematic illustrations for describing an exemplary application to a layer thickness variation within the optically effective part or layer system of a mirror or a mirror arrangement, in which laterally adjacent regions or elements are shown in top view (FIGS. 11A, 11C and 11E) and sectional view (FIGS. 11B, 11D and 11F) having a constant sublayer thickness ratio but a varying period length between a first sublayer (FIGS. 11C and 11D) and a second sublayer (FIGS. 11E and 11F) in the reflection layer system;

FIG. 12 shows a diagram for illustrating the wavelength-dependent reflectivity curve for the exemplary embodiment from FIGS. 11A-11F;

FIGS. 13A-13F show schematic illustrations for describing an exemplary application to a layer thickness variation within the optically effective part or layer system of a mirror or a mirror arrangement in a further embodiment, in which laterally adjacent regions or elements are shown in top view (FIGS. 13A, 13C and 13E) and sectional view (FIGS. 13B, 13D and 13F) having sublayer thickness ratios which vary from region to region (FIGS. 13D and 13F) but have constant respective optical path lengths;

FIG. 14 shows a diagram for illustrating the wavelength-dependent reflectivity curve for the exemplary embodiment from FIGS. 13A-13F; and

FIG. 15 shows a schematic illustration of a projection exposure apparatus designed for operation in the EUV wavelength range.

### DETAILED DESCRIPTION

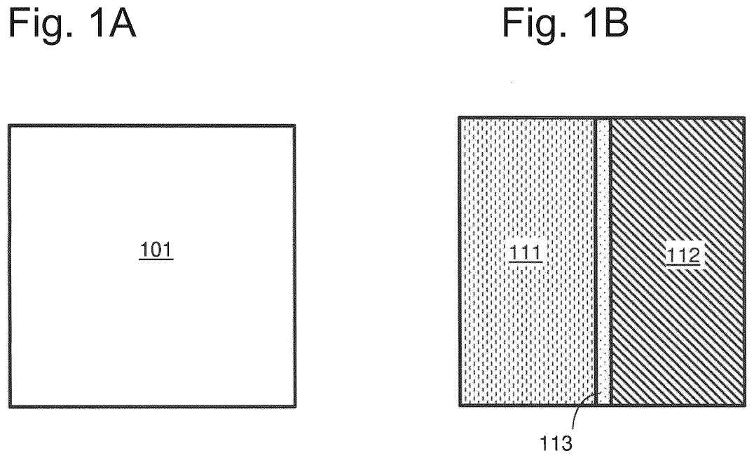

It is assumed below that, when producing a mirror arrangement (which can be designed for operation in the EUV or else the DUV wavelength range) using, for example, a magnetron coating arrangement or an electron beam coating arrangement, a desired layer thickness profile and/or a desired layer composition of the layer system (including the reflection layer system as well as any functional layers) should be varied. Exemplary embodiments of a method according to the invention are explained below with reference to the schematic diagrams in FIGS. 1A-8G.

According to the invention, reference is made to the application of the method to the production of a mirror arrangement.

However, the disclosure is not limited to this, and so the produced optical element may also be, for example, an individual mirror or a lens element, wherein the layer system can be deposited, for example, in order to form an anti-reflective layer (AR layer).

The embodiments described below have the feature in common that, when producing a mirror arrangement in a coating process carried out in a coating arrangement, in which at least one substrate is supplied with coating material from at least one source for depositing a respective layer system on the substrate, the layer thickness profile and/or the layer composition of a layer system is/are varied by targeted spatially resolved selection and/or treatment of the coating material and/or the substrate, such that zones that are laterally adjacent to one another in at least one predefined direction and each have a defined layer thickness profile and a defined layer composition are formed, wherein these zones differ from each other in their layer thickness profile and/or their layer composition, wherein the respective average dimension of the zones in the predefined direction is in the range of 0.1 mm to 2 cm.

In this case, the layer thickness profile and/or layer composition can be set such that the reflectivity for the targeted setting of the reflectance at the respective operating wavelength (e.g. for EUV radiation) is partially suppressed or attenuated in the respective, relevant zones or that the relevant zone even has an absorbing effect at the respective operating wavelength.

The spatially resolved selection of the coating material according to the invention can be carried out in a different way, as described below, but these embodiments can also be combined with each other in a suitable manner. In particular, the spatially resolved selection of the coating material according to the invention may comprise partially deflecting coating material (with the consequence that this coating material no longer contributes to the deposition of the layer system on the mirror substrate) or partially blocking out coating material (e.g. via a protective resist, with which the mirror substrate is treated before carrying out the coating process, or via a mask which is arranged at a defined distance from the mirror substrate while the coating process is being carried out).

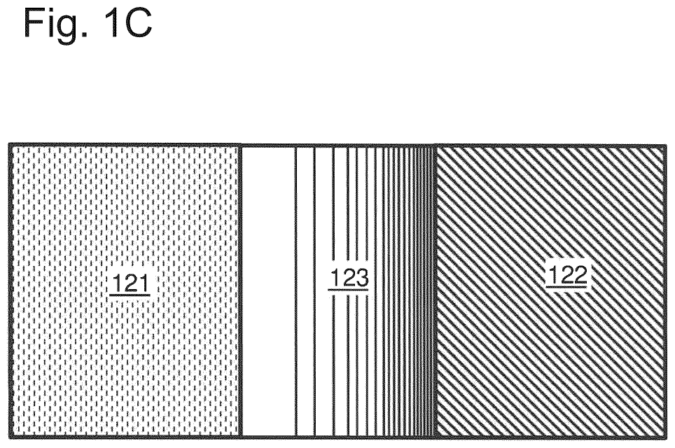

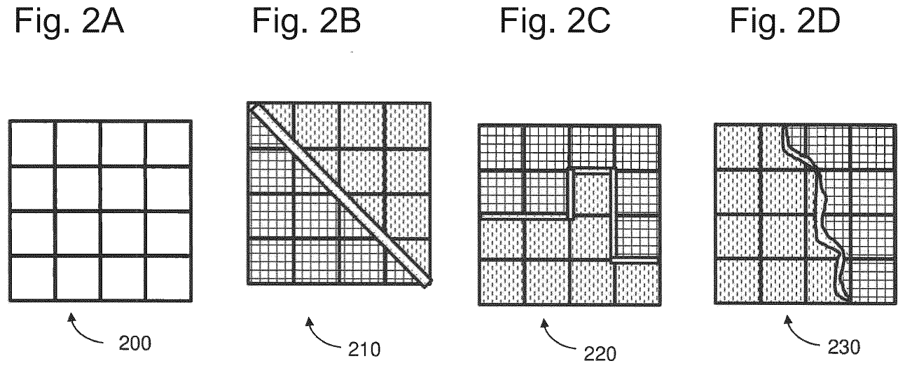

FIGS. 1A-2D initially show schematic illustrations for explaining this concept associated with the invention.

In this case, zones 111, 112 of different layer thickness and/or different layer composition that are separated from one another, e.g. according to FIG. 1B, are formed on a mirror substrate designated “101” in FIG. 1A and are separated from each other by a transition zone designated “113” (wherein the width of the transition zone can be less than 1 mm, for example). Preferably, therefore, the transition zone 113 (in which the layer properties are essentially undefined) serving as the zone boundary is limited to a comparatively narrow region with a width of less than 1 mm.

According to a further embodiment, a transition zone between adjacent zones has a predefined monotonous profile of a function describing the location dependence of the layer thickness and/or the layer composition. The width of this transition zone can be in particular in the range of 0.1 mm to 2 cm. As indicated in FIG. 1C, a transition zone 123 having a gradient profile with a gradual variation of layer thickness and/or layer composition can also be realized on the mirror substrate between zones 121, 122.

FIGS. 2A-2D show schematic illustrations for describing an application of the invention to a mirror array, which in turn may have blocks of individual micromirrors in the form of microelectromechanical systems (=“MEMS mirror”). Such a block is illustrated schematically in each of the figures and designated “200” to “230” respectively in FIGS. 2A-2D, wherein the respective zone boundaries between the zones of different layer thickness and/or different layer composition generated according to the invention can run between adjacent MEMS mirrors (see FIG. 2C) or within the MEMS mirrors (see FIG. 2B and FIG. 2D).

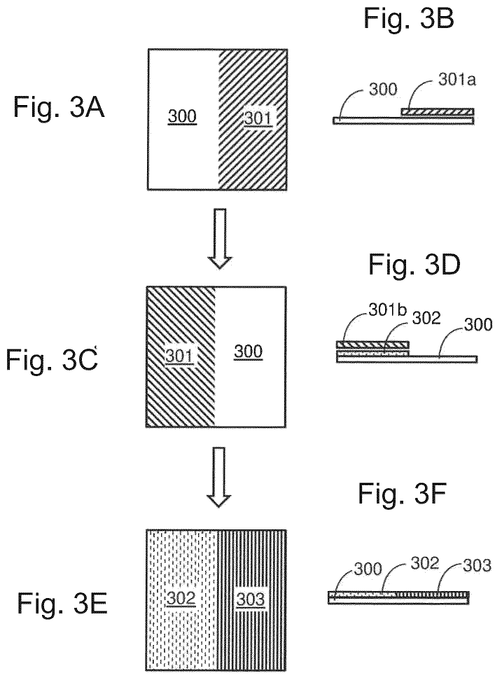

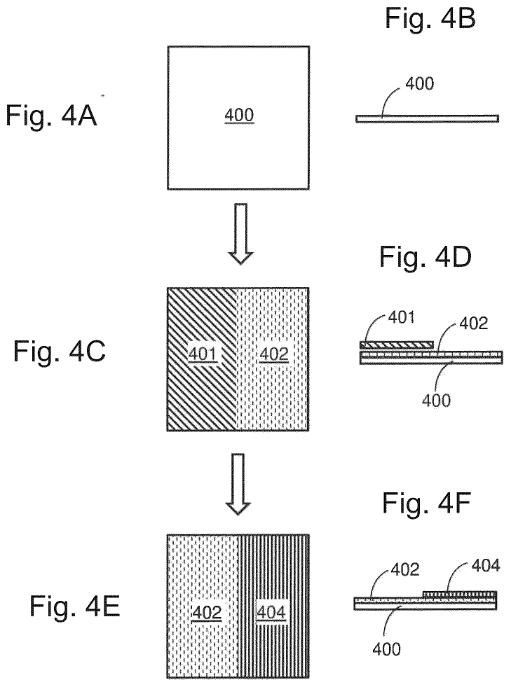

FIGS. 3A-3F and FIGS. 4A-4F each show schematic illustrations for explaining feasible embodiments of the method according to the invention using a mask which is arranged at a defined distance from the mirror substrate while the coating process is being carried out. According to FIG. 3A (=top view) and FIG. 3B (=side view), a mask 301a is placed in a first coating pass above a mirror substrate 300 and the mirror substrate 300 is coated with a layer system 302 only in the region not covered by the mask 301. In a subsequent, second coating pass, a mask 301b is placed above the previously partially coated mirror substrate 300, with the result that a layer system 303 is now deposited in the region not covered by this mask 301b. FIG. 3E (=top view) and FIG. 3F (=side view) schematically show the result of the coating process in the form of two adjacent zones corresponding to the layer systems 302, 303 deposited in the first and second coating pass.

The exemplary embodiment schematically illustrated in FIGS. 4A-4F in an analogous manner differs from that from FIGS. 3A-3F in that the first coating pass according to FIGS. 4A-4B is still carried out without the use of a mask and thus completely over the mirror substrate 400, whereupon, in the second coating pass, with partial covering of the mirror substrate 400 with a mask 401, the layer system (designated “402”) applied in the first coating pass is overcoated with a further layer system 404 only in the region not covered by the mask 401. FIGS. 4A-4F show the result of the coating process in the form of two adjacent zones corresponding to the layer systems 402, 404 deposited in the first and second coating pass.

The mask(s) used in the above-described embodiments is or are mounted firmly over the mirror substrate in the respective coating passes, wherein suitable distances between the mask and the mirror substrate can typically be in the range of 0.1 mm to 1 cm. The width of the transition zone between adjacent zones of different layer thickness and/or different layer composition is determined by the rear vapor deposition dependent on the specific deposition method (e.g. electron beam evaporation, magnetron sputtering, ion beam sputtering), which in turn depends on the distance between the mask and the surface of the mirror substrate. The profile of the achieved reflectivity in the transition region or at the zone boundary can thus be controlled via the distance between the mask and the mirror substrate surface, wherein this distance should be as small as possible for the smallest possible zone width and zone boundaries that are defined as well as possible. Furthermore, the spectral reflection or transmission, for example, can also be varied particularly strongly within a very short distance, whereby not only a variation of the reflectivity at a certain wavelength, but a shift of the entire response or reflectivity spectrum can be achieved.

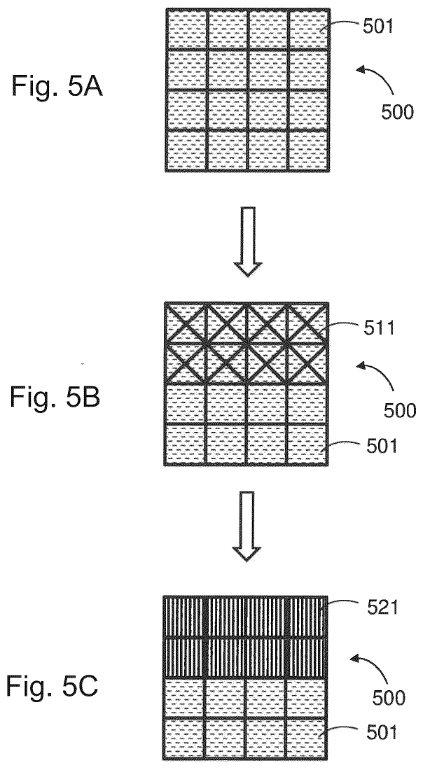

FIGS. 5A-5C show schematic illustrations for explaining a further embodiment, wherein a partial tempering of the mirror substrate (in order to change or modify the material mix or the density of the (e.g. Initially more porous) material) is carried out after carrying out a coating process. In particular, a region of a mirror array (e.g. a homogeneously coated block 500 of MEMS mirrors 501) initially homogeneously coated according to FIG. 5A can be selectively tempered, which can be carried out using a laser, for example. As a result of absorption of the laser radiation or energy by the mirror substrate material, local heating (and possibly melting) can take place, which is accompanied by a shift in the wavelength-dependent reflectivity via the associated local density change (corresponding to selective compaction of the mirror substrate material). Depending on the specific application scenario, the resulting reflectivity in the tempered region of the mirror substrate or mirror array can be attenuated (and, if desired, possibly also completely suppressed) at a defined wavelength or in a predefined wavelength range. In FIG. 5B, that region of the block 500 which was tempered as described above is designated “511”, but FIG. 5C shows the result of the entire treatment process (with a region 521 of changed reflectivity as a result of the tempering). Depending on the specific use scenario, the reflectivity can be attenuated or suppressed or also increased by tempering (if, for instance, the reflectivity spectrum was initially set for a higher wavelength than the operating or used wavelength).

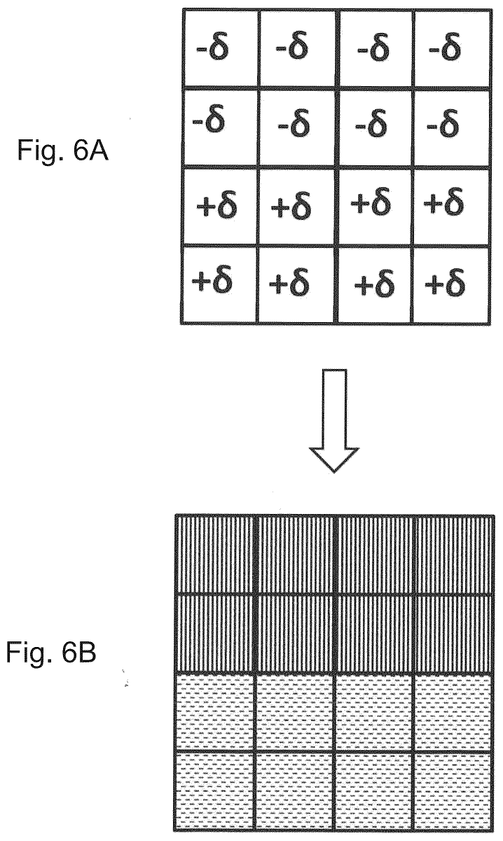

FIGS. 6A-6B and 7A-7B show schematic illustrations for explaining a further feasible embodiment, in which the selection of the respective coating material comprises partially electrically charging the mirror substrate. For this purpose, the substrate is subjected to an electrical potential selected appropriately depending on the maximum energy of the coating material particles. Merely by way of example, in magnetron sputtering, the electrical voltage applied to the substrate for this purpose can be in the range of up to 20 volts. As indicated in FIGS. 6A and 7A via different specific examples, different mirror substrate regions or mirror substrates of different MEMS mirrors can be electrically charged positively or negatively. This selective charging of the mirror substrate or the MEMS mirrors also enables the targeted setting of different layer thicknesses.

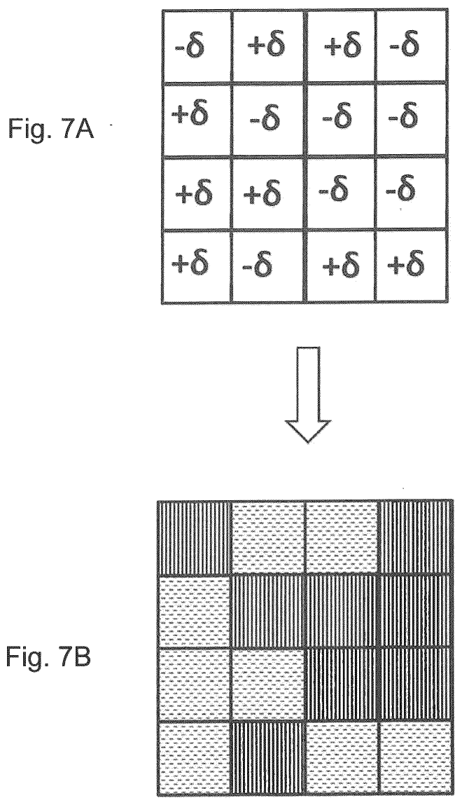

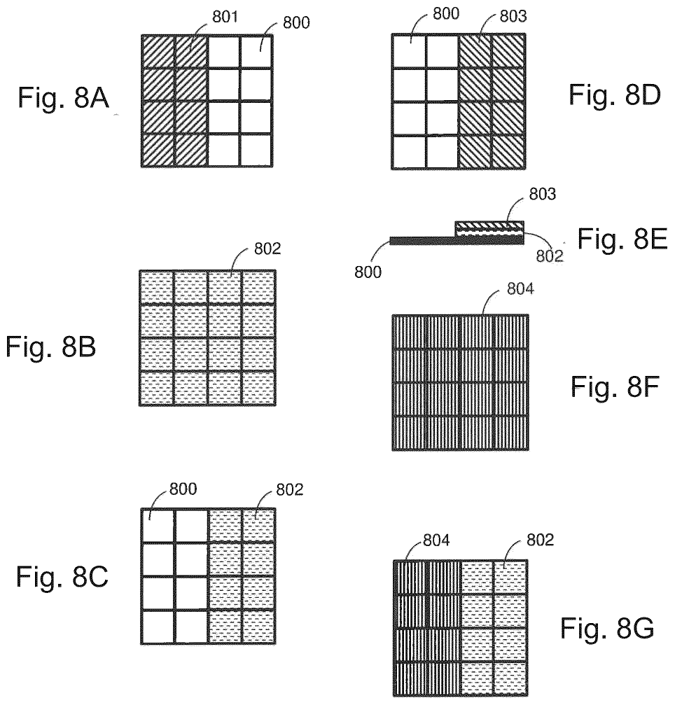

FIGS. 8A-8G show schematic illustrations for explaining a further feasible embodiment of a method according to the invention, wherein coating material is partially blocked out via a protective resist, with which the mirror substrate is treated before carrying out the coating process. In the exemplary embodiment illustrated, after a prestructuring of a mirror substrate 800 with a protective resist 801 that is carried out in the step in FIG. 8A, a homogeneous coating (cf. FIG. 8B) is first carried out by applying a layer system 802 followed by a removal of the protective resist 801 (cf. FIG. 8C), whereupon the mirror substrate 800 has the previously applied layer system 802 only in its region previously not covered by the protective resist 801. After a restructured application of a protective resist 803 to the previously coated region or the layer system 802, as indicated in FIG. 8D (in top view) and in FIG. 8E (in section), a homogeneous coating is carried out again according to FIG. 8F by depositing a further layer system 804, with the result that, after removing the protective resist 803 according to FIG. 8G, this further layer system 804 is present only in the region most recently not covered by the protective resist 803. As a result, two separate zones of different layer composition and/or layer thickness corresponding to the previously applied layer systems 802 and 804 are thus obtained.

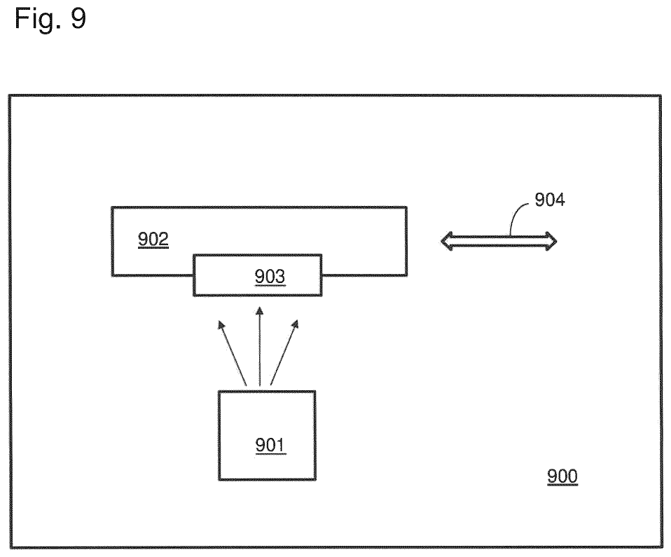

FIG. 9 shows a schematic illustration of a basic, representative structure of a coating arrangement 900 according to the invention. According to FIG. 9, at least one substrate 903 held by a holder 902 is received in a process chamber (vacuum chamber) 900 and a relative movement is carried out between the substrate 903 and a source 901 (e.g. a target respectively providing a coating material), as indicated by the double-headed arrow 904. On the holder 902, a plurality of mirror substrates can also be arranged in each case and grouped into individual blocks. In order to deposit a respective layer system on each of the mirror substrates, the coating holder 902 carrying the mirror substrates is guided via the source 901 or the respective target along a predefined trajectory.

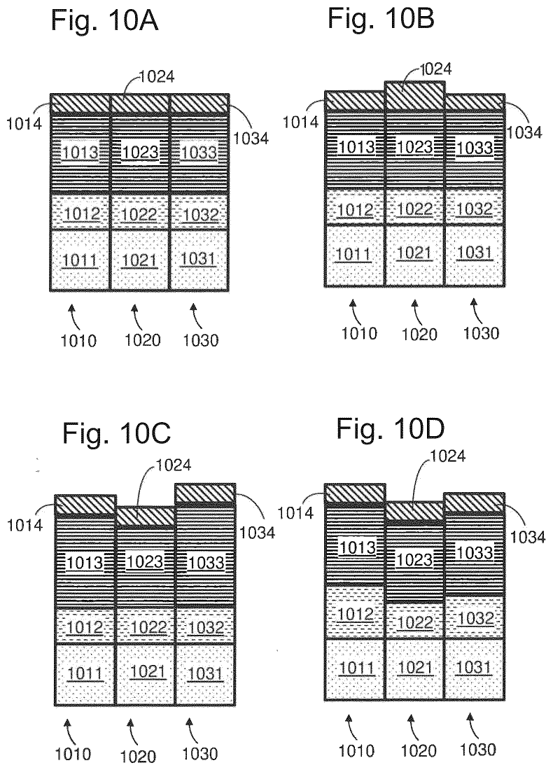

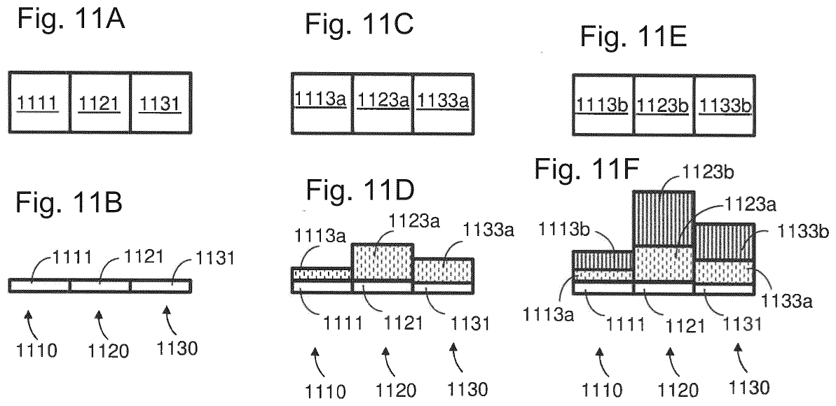

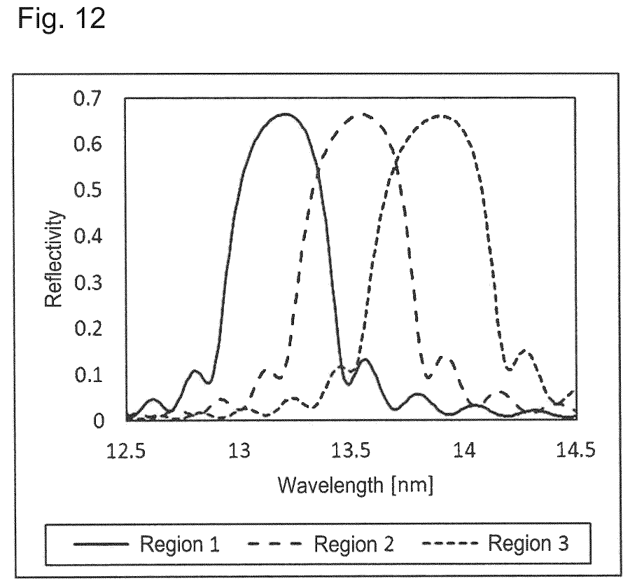

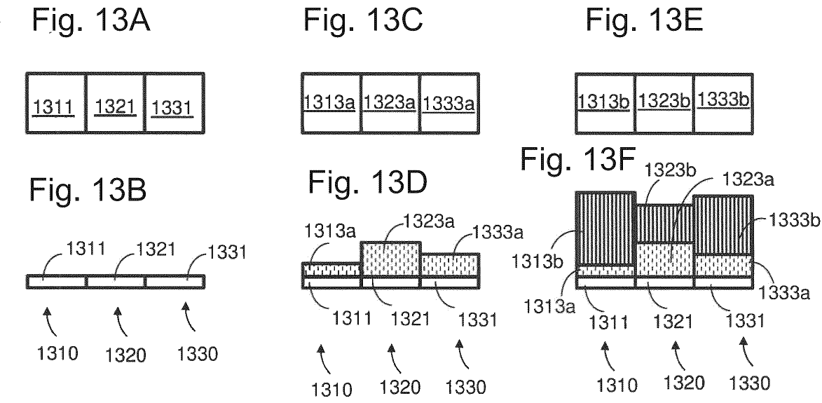

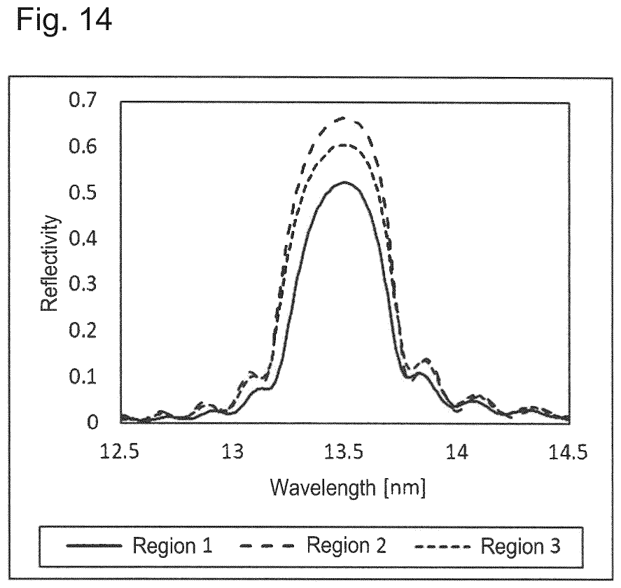

Specific application examples in which the method according to the invention for producing a mirror or a mirror arrangement is used in different ways are described below with reference to the schematic illustrations of—FIGS. 10A-11F and, FIGS. 13A-13F, respectively, and the diagrams of FIG. 12 and FIG. 14, respectively.

The method according to the invention for varying a layer thickness profile and/or a layer thickness composition can be fundamentally applied to different sublayers or sublayer systems within the entire layer system. Specifically, this variation can take place, as illustrated below first with reference to FIGS. 10A-10D, in the optically effective part or layer system (see FIG. 10C), in the part or a capping layer located above this optically effective layer system (see FIG. 10B) and/or in a part or a bottom layer located below the optically effective layer system (see FIG. 10D).

The above-mentioned variations of the layer thickness according to the invention in the optically effective part or layer system or the part located above or below it can also be combined with each other as desired. Furthermore, as an alternative or in addition to the layer thickness variation, the composition of the respective sublayers or sublayer systems can also be varied.

FIG. 10A shows, in only a schematic and greatly simplified (sectional) illustration for describing the above-mentioned principle, different, laterally adjacent regions 1010, 1020, 1030 of a mirror or a mirror arrangement (wherein these regions can also correspond in particular to different mirror elements in the case of a mirror arrangement). In the structure illustrated, the reference numerals “1011”, “1021”, “1031” each refer to the substrate, the reference numerals “1012”, “1022”, “1032” each refer to the bottom layer, the reference numerals “1013”, “1023”, “1033” each refer to the optically effective part, and the reference numerals “1014”, “1024”, “1034” each refer to the part located above it, e.g., the capping layer.

In a specific application, the capping layer varied with respect to the layer thickness in the different regions 1010, 1020, 1030 in the illustrated exemplary embodiment according to FIG. 10B may be an absorber layer for absorbing DUV light. For feasible configurations of the absorber layer, reference is made to DE 10 2015 208 214 A1.

In a further specific application, the capping layer varied in the exemplary embodiment according to FIG. 10B may also be an absorber layer in the form of an intensity adaptation filter or a neutral density filter, for example in order to compensate for different intensity distributions due to different working light sources. In this regard, with respect to representative configurations, reference is made to DE 10 2016 224 113 A1.

The bottom layer whose layer thickness is varied according to FIG. 10D can be, in a specific application example, a stress compensation layer or a compensation layer which reduces a transfer of mechanical stresses between the substrate and the optically effective part or layer system. In this regard, with respect to representative configurations, reference is made to DE 10 2015 225 510 A1.

The optically effective part or layer system whose layer thickness is varied laterally according to FIG. 10C can be, for example, a reflection layer system consisting of an alternating sequence of individual layer stacks (of a molybdenum layer and a silicon layer respectively), as described below with reference to FIG. 11A to FIG. 14, using exemplary embodiments.

Referring first to FIGS. 11A-11F, laterally adjacent regions which have a different configuration with respect to their layer thickness are again designated “1110”, “1120”, “1130”. FIG. 11A, FIG. 11C and FIG. 11E each show schematic top views from different locations in the overall layer system, and FIG. 11B, FIG. 11D and FIG. 11F each show schematic sectional views. Furthermore, the schematic illustrations symbolize the gradual construction of the layer system with the substrate (designated “1111”, “1121”, “1131” in FIGS. 11a-11b), the first sublayer of e.g. molybdenum (designated “1113a”, “1123a”, “1133a”in FIGS. 11C-11D) and the second sublayer of e.g. silicon (designated “1113b”, “1123b”, “1133b” in FIGS. 11E-11F), wherein the corresponding reflection layer system is constructed from these sublayers in an alternating sequence. FIGS. 13A-13F show similar schematic illustrations of a further embodiment, wherein the components that correspond and are essentially functionally the same as in FIGS. 11E-11F are designated by reference numerals increased by “200”.

The embodiments of FIGS. 11A-11F and FIGS. 13A-13F differ from each other in that, according to FIGS. 11A-11F, the respective thickness ratio of the sublayers 1113a and 1113b, 1123a and 1123b, 1133a and 1133b is constant over the different regions 1110, 1120, 1130, but the “period length” of the multilayer system formed (i.e. the respective total thickness of the first and second sublayer) varies over the relevant regions 1110, 1120, 1130. As a result of this, according to the diagram of FIG. 12, the peak wavelength varies in the wavelength-dependent reflectivity profile over the regions (for a constant value of the peak reflectivity). In contrast, in the embodiment according to FIGS. 13A-13F, the respective thickness ratio of the first and second sublayer changes from region (1310, 1320 or 1330) to region, but the respective optical path length remains constant. The result of this configuration is that, according to the diagram of FIG. 14, the peak wavelength remains constant over the regions, but the peak reflectivity varies from region to region.

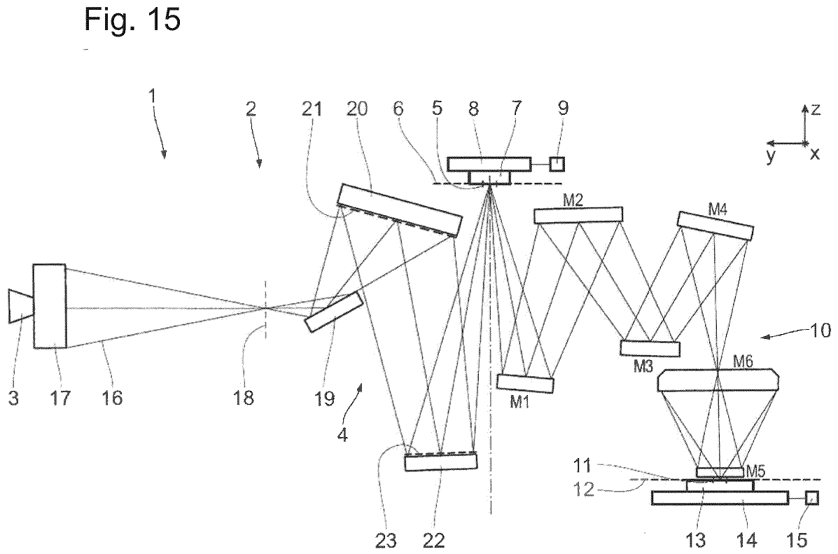

FIG. 15 schematically shows in meridional section a feasible structure of a microlithographic projection exposure apparatus designed for operation in the EUV range.

According to FIG. 15, the projection exposure apparatus 1 comprises an illumination device 2 and a projection lens 10. One embodiment of the illumination device 2 of the projection exposure apparatus 1 has, in addition to a light or radiation source 3, an illumination optical unit 4 for illuminating an object field 5 in an object plane 6. In an alternative embodiment, the light source 3 may also be provided as a module separate from the rest of the illumination device. In this case, the illumination device does not comprise the light source 3.

This apparatus 1 is configured to expose a reticle 7 arranged in the object field 5. The reticle 7 is held by a reticle holder 8. The reticle holder 8 is displaceable in particular in a scanning direction with a reticle displacement drive 9. For explanation purposes, a Cartesian xyz coordinate system is depicted in FIG. 15. The x-direction runs perpendicularly to and into the plane of the drawing. The y-direction runs horizontally, and the z-direction runs vertically. The scanning direction runs along the y-direction in FIG. 15. The z-direction runs perpendicularly to the object plane 6.

The projection lens 10 serves for imaging the object field 5 into an image field 11 in an image plane 12. A structure on the reticle 7 is imaged onto a light-sensitive layer of a wafer 13 arranged in the region of the image field 11 in the image plane 12. The wafer 13 is held by a wafer holder 14. The wafer holder 14 is displaceable in particular along the y-direction with a wafer displacement drive 15. The displacement, firstly, of the reticle 7 by the reticle displacement drive 9 and, secondly, of the wafer 13 by the wafer displacement drive 15 may be synchronized with one another.

The radiation source 3 is an EUV radiation source. The radiation source 3 in particular emits EUV radiation, which is also referred to below as used radiation or illumination radiation. In particular, the used radiation has a wavelength in the range of between 5 nm and 30 nm. The radiation source 3 may be, for example, a plasma source, a synchrotron-based radiation source or a free electron laser (FEL). The illumination radiation 16 emanating from the radiation source 3 is focused by a collector 17 and propagates through an intermediate focus in an intermediate focal plane 18 into the illumination optical unit 4. The illumination optical unit 4 comprises a deflection mirror 19 and, arranged downstream thereof in the beam path, a first facet mirror 20 (having schematically indicated facets 21) and a second facet mirror 22 (having schematically indicated facets 23). The facet mirrors 21, 22 may be produced e.g. using the method according to the invention or using a coating arrangement according to the invention.

The projection lens 10 comprises a plurality of mirrors Mi (i=1, 2, . . . ), which are consecutively numbered according to their arrangement in the beam path of the projection exposure apparatus 1. In the example illustrated in FIG. 15, the projection lens 10 comprises six mirrors M1 to M6. Alternatives with four, eight, ten, twelve or any other number of mirrors Mi are likewise feasible. The penultimate mirror M5 and the last mirror M6 each have a through-opening for the illumination radiation 16. The projection lens 10 is a doubly obscured optical unit. The projection lens 10 has an image-side numerical aperture that is greater than 0.5 and may also be greater than 0.6 and may be for example 0.7 or 0.75.

Even though the invention has been described on the basis of specific embodiments, numerous variations and alternative embodiments will be apparent to a person skilled in the art, for example through combination and/or exchange of features of individual embodiments. Accordingly, such variations and alternative embodiments are also included within the scope of the present invention, which is restricted only within the meaning of the accompanying patent claims and equivalents thereof.

What is claimed is:

1. A method for producing an optical element in a coating process carried out in a coating arrangement, comprising:
supplying at least one substrate with coating material from at least one source for depositing a layer system on the at least one substrate, wherein said depositing comprises:
forming a plurality of zones that are laterally adjacent to one another in at least one predefined direction, each zone having a defined layer thickness profile and a defined layer composition, by targeted spatially resolved selection and/or treatment of the deposited coating material and/or the at least one substrate, during the producing of the optical element, wherein the zones differ from one another in the layer thickness profile and/or the layer composition;
wherein the zones each range in average dimension in the predefined direction from 0.1 mm to 2 cm;
wherein the optical element produced is a mirror array with a plurality of mirror elements; and
generating, for further substrates of further mirror elements of the mirror array, mutually different layer thickness profiles and/or layer compositions for the deposited layer system.

2. The method as claimed in claim 1, wherein the optical element produced is a microlithographic optical element.

3. The method as claimed in claim 1, wherein the laterally adjacent zones comprise two adjacent zones and a transition zone between the adjacent zones, and wherein the transition zone has a maximum width of 1 mm.

4. The method as claimed in claim 1, wherein the laterally adjacent zones comprise two adjacent zones and a transition zone between the adjacent zones, and wherein the transition zone has a predefined monotonous profile of a function describing a location dependence of the layer thickness and/or the layer composition.

5. The method as claimed in claim 1, further comprising generating a plurality of further zones, each with a defined layer thickness profile and a defined layer composition, which differ in the layer thickness profile and/or the layer composition, on the at least one substrate.

6. The method as claimed in claim 1, wherein the selection of the coating material comprises partially blocking out and/or partially deflecting the coating material such that the coating material does not contribute to the deposition of the layer system on the at least one substrate.

7. The method as claimed in claim 6, wherein the partial blocking out of the coating material takes place via at least one mask which is arranged at a defined distance from the at least one substrate during the coating process.

8. The method as claimed in claim 7, wherein the defined distance is between 0.1 mm and 2 cm.

9. The method as claimed in claim 1, wherein the selection of the coating material comprises partially electrically charging the at least one substrate.

10. The method as claimed in claim 1, further comprising partially blocking out the coating material via a protective resist, with which the at least one substrate is treated before the coating process is carried out.

11. The method as claimed in claim 1, wherein the treatment of the deposited coating material and/or the substrate comprises partially tempering the at least one substrate after the coating process is carried out.

12. The method as claimed in claim 1, wherein the optical element is configured for an operating wavelength of less than 400 nm.

13. The method as claimed in claim 12, wherein the optical element is configured for an operating wavelength of less than 200 nm.

14. The method as claimed in claim 1, wherein the optical element is configured for an operating wavelength of less than 30 nm.

15. The method as claimed in claim 14, wherein the optical element is configured for an operating wavelength of less than 15 nm.

16. The method as claimed in claim 1, wherein the spatially resolved selection and/or treatment of the deposited coating material comprises removing at least some of the coating material.

17. The method as claimed in claim 1, wherein the spatially resolved selection and/or treatment of the deposited coating material comprises implanting material.

18. The method as claimed in claim 1, wherein the spatially resolved selection and/or treatment of the deposited coating material and/or the at least one substrate comprises modifying the at least one substrate and/or a surface of the at least one substrate and/or a previously deposited material.
